(19) United States
(12) Patent Application Publication
(10) Pub. No.: US 2025/0250855 A1
(43) Pub. Date: Aug. 7, 2025

(54) RETRACTABLE SCREEN ASSEMBLIES AND METHODS

(71) Applicant: ANDERSEN CORPORATION, Bayport, MN (US)

(72) Inventors: Kelly E. Hemping, Runnells, IA (US); Michael J. Wingert, Dallas Center, IA (US)

(21) Appl. No.: 19/045,041

(22) Filed: Feb. 4, 2025

Related U.S. Application Data
(60) Provisional application No. 63/549,917, filed on Feb. 5, 2024.

(51) Int. Cl. E06B 9/54

(52) U.S. Cl. CPC E06B 9/54; E06B 2009/543

(57) ABSTRACT

Retractable screen assemblies having cores with tension sections and methods are described herein. The retractable screen assemblies include features configured to promote parallel (or nearly parallel) extension and retraction in a retractable screen assembly in which the edges of the screen material are retained during extension and retraction.

### RELATED APPLICATION

This application claims the benefit under 35 U.S.C. Section 119 of U.S. Provisional Patent Application Ser. No. 63/549,917 entitled “RETRACTABLE SCREEN ASSEMBLIES AND METHODS” and filed on Feb. 5, 2024, which is incorporated herein by reference in its entirety.

This invention relates to retractable screen assemblies having cores with tension sections and methods.

Retractable screens are, in some embodiments, used to prevent passage of, e.g., insects, etc. through building openings. In particular, retractable screens are often used in windows, doorways and other openings where passage through the opening is desired.

### SUMMARY

Retractable screen assemblies having cores with tension sections and methods are described herein for use in building openings, with the screen material being deployed over the building opening when needed and safely stored on one side of the opening when the screen material is not needed.

The retractable screen assemblies described herein can be used in building openings that may or may not be otherwise closed by one or more doors and/or windows. In other words, the retractable screen assemblies may be used in building openings in which one or more doors are installed, in which one or more windows are installed, in which at least one window and at least one door are installed, or in building openings in which no doors or windows are installed.

The screen material used in the retractable screen assemblies described herein is configured to be wound and unwound from a rotating core and, thus, has sufficient flexibility and strength to be repeatedly wound and unwound as needed. The screen material may be constructed of one or more metallic materials, polymeric materials, natural materials (e.g., cotton, linen, bamboo, etc.), and combinations of any two more materials. In one or more embodiments, the screen material may include apertures of selected sizes (to, e.g., inhibit the passage of insects, etc.) and may also provide a selected level of opacity to, e.g., limit or promote light transmission etc. In one or more embodiments, the screen material may preferably be in the form of insect screen material.

The retractable screen assemblies described herein may, in one or more embodiments, include features configured to promote parallel (or nearly parallel) extension and retraction in a retractable screen assembly in which the edges of the screen material are retained during extension and retraction. Such control over extension and retraction also provides for proper alignment of a pull bar or other apparatus on a leading edge of the screen material with the core on which the screen material is wound or collected when the retractable screen assembly is in its retracted configuration.

Many retractable screen assemblies include flexible edge retention features commonly referred to as zipper tapes attached to the edges of the screen material to create a screen cloth assembly that can be rolled onto a central core when the retractable screen assemblies are in their retracted configurations. A torsion spring is installed in the central core with, for example, one end fixed to the inside diameter of the core and the other end fixed to a stationary bracket to provide for manual extension and automatic retraction of the screen material.

In one or more embodiments using zipper tape as a flexible edge retention feature, the teeth attached to the edges of the zipper tape are typically thicker than the screen material such that the thicker zipper tape retainers create a larger diameter in a rolled assembly. Because of that larger diameter, tension in the retractable screen assembly is transferred from the core along the zipper tapes with the screen material between the zipper tape retainers being in a slack or on tension condition. In an ideal situation the zipper tape retainers at opposite edges of the screen material will lay on top of each other as the screen material and zipper tapes are wound onto a core such that the zipper tapes provide relatively equal diameters at each end of the core when the screen material is rolled onto the core. In such a situation, the leading edge/pull bar of a retractable screen assembly moves towards and away from the core in an even an parallel condition relative to the core.

In some situations, however, variability in the zipper tape attachment process can cause the zipper tape retainers to become slightly wavy and/or less parallel on the opposing edges of the screen material. If the opposing zipper tape retainers are attached at slightly different angles and/or have a difference in straightness across the length of the screen material, winding of the zipper tape at opposite ends of a core can result in significantly different diameters. Those different diameters can cause the screen material to extend and retract at slightly different rates from one end of the role of screen material to the other, resulting in the leading edge/pull bar to become uneven or parallel relative to the core.

Unlike the zipper tapes in some embodiments, the screen material located between the zipper tape retainers is very consistent in thickness and straightness and is generally not altered by the retainer attachment process. In one or more embodiments, the consistency of the screen material is leveraged to carry spring tension in the retractable screen assembly. With the consistent thickness and straightness of the screen material, extension and retraction of the screen material from the core typically provides for parallel movement of the leading edge/pull bar towards and away from the core during retraction and deployment of the screen material.

In one or more embodiments, tension from the core of the retractable screen assembly is carried in the screen material by providing a tension section on the core, with the tension section having an effective diameter that is greater than the core diameter outside of the tension section. That larger diameter ensures that the screen material is in tension along a tension zone typically aligned with the tension section along the length of the screen material. In one or more embodiments, it may be preferred that the tension section and the tension zone created by the tension section be aligned with but spaced apart from an edge of the screen material.

In addition to providing for even/parallel advancement and retraction of the leading edge/pull bar of the retractable screen assembly, the tension sections and tension zones created in the screen material by the tension sections may also reduce the formation of wrinkles in the screen material near the edges of the retainers.

It has been found that a variety of factors can be adjusted to provide different performance parameters in retractable screen assemblies using cores having tension sections as described herein. For example, it has been found that even extension and retraction of the pull bar/screen material leading edge can be improved by increasing the diameter of the tension sections and/or moving the tension sections further away from the edges of the screen material.

It has also been found that reducing the diameter of the tension sections and/or moving the tension sections closer to the edges of the screen material can result in shortening and/or reducing wrinkling or deformation of the screen material between the outer ends of the tension sections and the edges of the screen material.

It has further been found that reductions in friction and increases in retraction speed in the retractable screen assemblies described herein can be obtained by reducing the diameter of the tension sections and/or moving the tension sections closer to the edges of the screen material.

In a first aspect, one or more embodiments of a retractable screen assembly as described herein include: a screen housing configured for attachment to a first side of a building opening; a core retained in the screen housing, the core comprising a core length extending along a winding axis from a first end to a second end; screen material wound on the core in the screen housing, the screen material comprising a first edge proximate the first end of the core, a second edge proximate the second end of the core, a leading edge extending from the first edge to the second edge, and a trailing edge extending from the first edge to the second edge, wherein the trailing edge is attached to the core and remains in the screen housing during use of the retractable screen assembly and wherein the screen material comprises a length measured between the leading edge and the trailing edge; and a pull bar attached to the leading edge of the screen material, the pull bar configured to unwind the screen material from the core when moved away from the screen housing; wherein the core comprises a tension section occupying only a portion of the core length between the first edge of the screen material and the second edge of the screen material, wherein the tension section comprises a tension section effective diameter that is greater than an effective core diameter outside of the portion of the core length occupied by the tension section, such that the screen material is in tension along a tension zone aligned with the tension section along the length of the screen material, the tension zone also aligned with but spaced apart from the first edge of the screen material.

In one or more embodiments of the retractable screen assemblies described herein, the screen material in the tension zone is configured to deliver an unwinding force to the core through the tension section as the pull bar is moved away from the core during deployment of the screen material and deliver a winding force to the pull bar as the screen material is wound on the core.

In one or more embodiments of the retractable screen assemblies described herein, the tension section effective diameter is 105 percent or more, 110 percent or more, 115 percent or more, or 120 percent or more of the effective core diameter between the tension section and the first edge of the screen material.

In one or more embodiments of the retractable screen assemblies described herein, the tension section effective diameter is 150 percent or less of the effective core diameter, 140 percent or less of the effective core diameter, or 130 percent or less of the effective core diameter between the tension section and the edge of the screen material. In one or more embodiments of the retractable screen assemblies described herein, the tension section comprises a section length measured along the winding axis that is 10 percent or more, 20 percent or more, 30 percent or more, 40 percent or more, 50 percent or more, 100 percent or more, 120 percent or more, or 150 percent or more of the tension section effective diameter. In one or more embodiments, the section length is 10 times or less, 8 times or less, 6 times or less, 4 times or less, or 2 times or less of the tension section effective diameter.

In one or more embodiments of the retractable screen assemblies described herein, the tension section extends along the core from an outer section end to an inner section end, wherein the outer section end is located closer to the first edge of the screen material than the inner section end, and wherein a section distance between the first edge of the screen material and the outer section end is 15 times or less, 12 times or less, 10 times or less, 8 times or less, 6 times or less, 4 times or less, 2 times or less, equal to or less than, 0.5 times or less, or 0.2 times or less of the tension section effective diameter. In one or more embodiments, the section distance between the first edge of the screen material and the outer section end of the tension section is 10 percent or more, 20 percent or more, 30 percent or more, 40 percent or more, or 50 percent or more of the tension section effective diameter.

In one or more embodiments of the retractable screen assemblies described herein, the tension section comprises a tension clip attached to the core, wherein the tension clip occupies a clip arc measured from the winding axis on a perimeter of the core, wherein the clip arc is greater than 180 degrees, 210 degrees or more, 240 degrees or more, 270 degrees or more, 300 degrees or more, or 330 degrees or more.

In one or more embodiments of the retractable screen assemblies described herein, the tension section comprises a first tension section occupying a first portion of the core length and wherein the retractable screen assembly comprises a second tension section occupying a second portion of the core length between the first tension section and the second edge of the screen material, wherein the second tension section comprises a second tension section effective diameter that is greater than an effective core diameter outside of the second portion of the core length occupied by the second tension section, such that the screen material is in tension along a second tension zone aligned with the second tension section along the length of the screen material, the second tension zone also aligned with but spaced apart from the second edge of the screen material.

In one or more embodiments of the retractable screen assemblies including first and second tension sections as described herein, the screen material in the second tension zone delivers an unwinding force to the core through the second tension section as the pull bar is moved away from the core during deployment of the screen material and deliver a winding force to the pull bar as the screen material is wound on the core.

In one or more embodiments of the retractable screen assemblies including first and second tension sections as described herein, the second tension section effective diameter is 105 percent or more, 110 percent or more, 115 percent or more, or 120 percent or more of the effective core diameter between the second tension section and the second edge of the screen material. In one or more embodiments, the second tension section effective diameter is equal to the tension section effective diameter of the first tension section.

In one or more embodiments of the retractable screen assemblies including first and second tension sections as described herein, the second tension section comprises a second section length measured along the winding axis that is 10 percent or more, 20 percent or more, 30 percent or more, 40 percent or more, 50 percent or more, 100 percent or more, 120 percent or more, or 150 percent or more of the second tension section effective diameter. In one or more embodiments, the second section length of the second tension section is 10 times or less, 8 times or less, 6 times or less, 4 times or less, or 2 times or less of the second tension section effective diameter.

In one or more embodiments of the retractable screen assemblies including first and second tension sections as described herein, the second tension section extends along the core from a second outer section end to a second inner section end, wherein the second outer section end is located closer to the second edge of the screen material than the second inner section end, and wherein a second section distance between the second edge of the screen material and the second outer section end is 15 times or less, 12 times or less, 10 times or less, 8 times or less, 6 times or less, 4 times or less, 2 times or less, equal to or less than, 0.5 times or less, or 0.2 times or less of the second tension section effective diameter. In one or more embodiments, the second section distance between the second edge of the screen material and the outer section end of the second tension section is 10 percent or more, 20 percent or more, 30 percent or more, 40 percent or more, or 50 percent or more of the second tension section effective diameter.

In one or more embodiments of the retractable screen assemblies including first and second tension sections as described herein, the second tension section comprises a second tension clip attached to the core, wherein the second tension clip occupies a second clip arc measured from the winding axis on a perimeter of the core, wherein the second clip arc is greater than 180 degrees, 210 degrees or more, 240 degrees or more, 270 degrees or more, 300 degrees or more, or 330 degrees or more.

In one or more embodiments of the retractable screen assemblies described herein, the retractable screen assembly comprises a first tape attached to the first edge of the screen material and a second tape attached to the second edge of the screen material, wherein the first tape is wound about the winding axis within the screen housing proximate the first end of the core, and wherein the second tape is wound about the winding axis within the screen housing proximate the second end of the core. In one or more embodiments, the retractable screen assembly comprises a first track extending away from the screen housing proximate the first end of the core and a second track extending away from the screen housing proximate the second end of the core, wherein a first end of the pull bar and the first tape pass through a first channel in the first track when the pull bar is moved away from the screen housing to unwind the screen material, and wherein a second end of the pull bar and the second tape pass through a second channel in the second track when the pull bar is moved away from the screen housing to unwind the screen material.

In one or more embodiments of the retractable screen assemblies including first and second tension sections as described herein, the second tension section effective diameter is 150 percent or less, 140 percent or less, or 130 percent or less of the effective core diameter between the second tension section and the second edge of the screen material.

In a second aspect, one or more embodiments of a method of deploying a retractable screen across a building opening includes: unwinding screen material wound on a core in a screen housing attached to a first side of a building opening by moving a pull bar attached to a leading edge of the screen material away from the screen housing along a deployment direction; wherein the unwinding comprises applying an unwinding force to a tension section of the core, wherein the tension section occupies only a portion of the core between a first edge of the screen material and a second edge of the screen material, wherein the tension section comprises a tension section effective diameter that is greater than an effective core diameter outside of the portion of the core occupied by the tension section; wherein the unwinding force is applied to the tension section by a tension zone extending from the pull bar to the tension section; and wherein the tension zone is aligned with but spaced apart from the first edge of the screen material.

In one or more embodiments of the methods of deploying a retractable screen across a building opening as described herein, the tension zone comprises a first tension zone and the unwinding force applied by the first tension zone is a first unwinding force, and the method comprises: applying a second unwinding force to a second tension section of the core, wherein the second tension section occupies only a portion of the core between a first tension section and the second edge of the screen material, wherein the second tension section comprises a second tension section effective diameter that is greater than an effective core diameter outside of the portion of the core occupied by the second tension section; wherein the second unwinding force is applied to the second tension section by a second tension zone extending from the pull bar to the second tension section; and wherein the second tension zone is aligned with but spaced apart from the second edge of the screen material. In one or more embodiments, the first unwinding force and the second unwinding force are equivalent to each other.

Where used herein, the terms “top” and “bottom” are used for reference relative to each other when the retractable screen assemblies described herein are properly installed in a building opening for movement in a horizontal direction. If the retractable screen assemblies described herein result in movement of the screen material in a vertical direction, it will be understood that the terms “top” and “bottom” would refer to opposite sides of the retractable screen assemblies described herein.

Where used herein, the terms “exterior” and “interior” are used in a relative sense, e.g., an exterior side and an interior side of a retractable screen assembly and any of its components describe opposite sides of the retractable screen assembly and any of its components. In other words, an exterior side could be found within the interior of a building or other structure that would conventionally define an interior and an exterior, while an interior side could be found outside of a building or other structure that would conventionally define an interior and an exterior. With respect to the illustrative embodiments described herein, the exterior and interior sides of the retractable screen assembly and any components thereof would be found on opposite ends along the Z-axis of the Cartesian coordinate systems provided in the figures.

The above summary is not intended to describe each embodiment or every implementation of the retractable screen assemblies and/or methods as described herein. Rather, a more complete understanding of the invention will become apparent and appreciated by reference to the following Description of Illustrative Embodiment and claims in view of the accompanying figures of the drawing.

### BRIEF DESCRIPTIONS OF THE DRAWING

FIG. 1 depicts one illustrative embodiment of a retractable screen assembly positioned in a building opening as described herein.

FIG. 2 is a view of the retractable screen assembly of FIG. 1 with the screen material partially deployed across the building opening.

FIG. 3 is an exploded assembly diagram of the retractable screen assembly of FIGS. 1-2 with the screen material removed to expose the core of the assembly.

FIG. 4 depicts components of the retractable screen assembly of FIG. 2 removed from the frame members including the screen housing.

FIGS. 5-7 depict some alternative illustrative embodiments of a core including one or more tension sections for use in one or more embodiments of the retractable screen assemblies described herein.

FIG. 8 is an enlarged perspective view of the components in a bottom right-hand corner of another illustrative embodiment of a retractable screen assembly similar to that depicted in FIG. 1 with the housing cutaway and the screen material removed to expose the components located therein.

FIG. 9 is a perspective view of the illustrative embodiment of the tension clip depicted in FIG. 8 that may be used to provide a tension section on a core of a retractable screen assembly as described herein.

FIG. 10 is a perspective view of another illustrative embodiment of a tension clip that may be used in one or more embodiments of the retractable screen assemblies described herein.

FIGS. 11-12 our enlarged cross-sectional views of the core and tension clip of the retractable screen assembly depicted in FIG. 8 taken in the X-Z-plane transverse to the winding axis 40-1. FIGS. 13-15 depict additional alternative illustrative embodiments of sleeve/tension clips that could be used in one or more embodiments of the retractable screen assemblies described herein

For reference, many of the figures includes Cartesian coordinate system axes to assist in description of the various components of the illustrative embodiments of the retractable screen assemblies described herein.

### DESCRIPTION OF ILLUSTRATIVE EMBODIMENTS

In the following description, reference is made to the accompanying figures of the drawing which form a part hereof, and in which are shown, by way of illustration, specific embodiments. It is to be understood that other embodiments may be utilized and changes may be made without departing from the scope of the present invention.

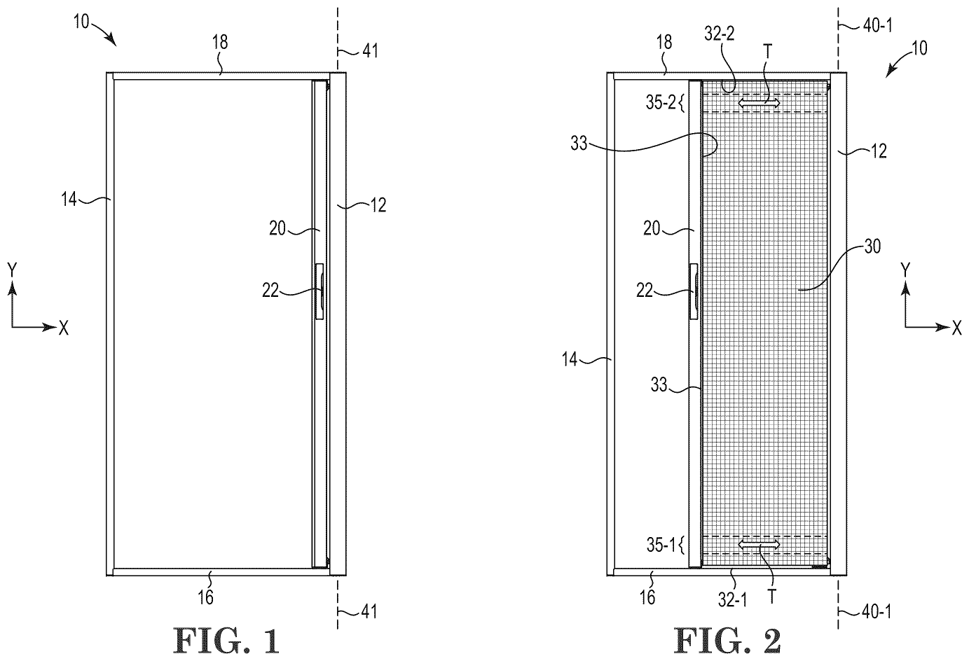

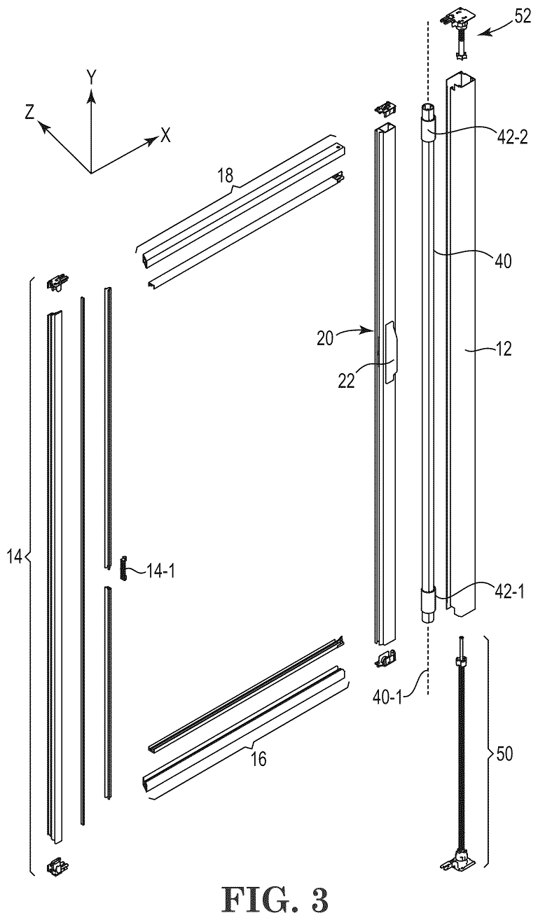

One illustrative embodiment of a retractable screen assembly 10 as described herein is depicted in FIGS. 1-3. In FIG. 2, the screen material 30 is partially extended from a screen housing 12 across a building opening on/in/over which the assembly 10 is positioned. FIG. 3 is an exploded assembly diagram of the retractable screen assembly of FIGS. 1-2 with the screen material removed to expose the core 40 and tensions sections 42-1 and 42-2 of the assembly.

The retractable screen assembly 10 as depicted in FIGS. 1-3 includes a screen housing 12, a latch housing 14 (including, e.g., a latch 14-1 as depicted in FIG. 3), and bottom and top screen tracks 16 and 18. The core 40 in the screen housing 12 defines a winding axis 40-1 extending through the screen housing 12.

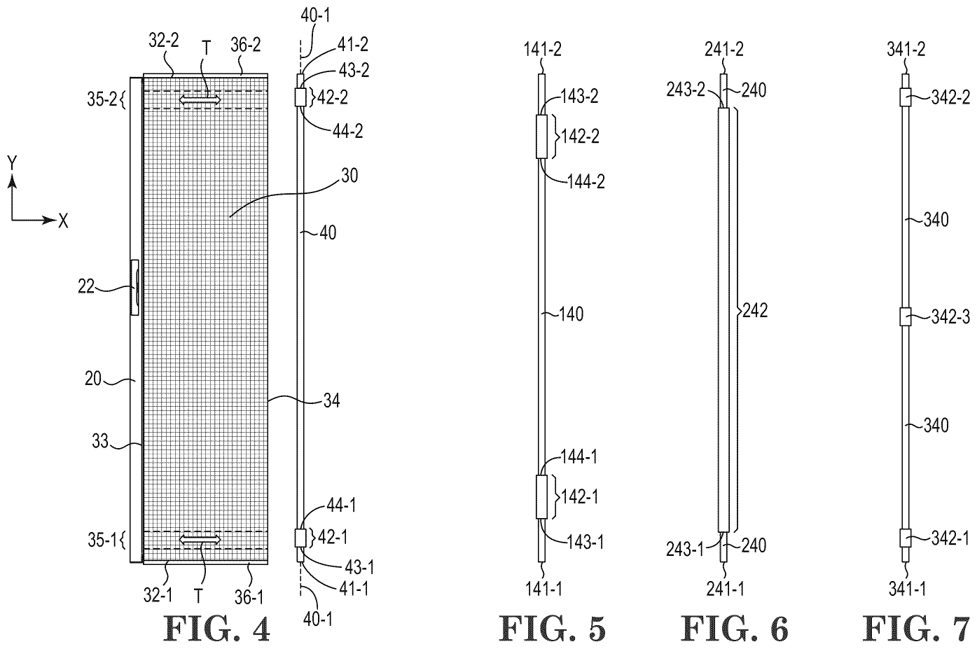

While FIG. 2 depicts the screen material 30 of the retractable screen assembly being partially extended across a building opening, FIG. 4 depicts the screen material 30, pull bar 20, and core 40 (with the core 40 being detached from the trailing edge 34 of the screen material 30 as well as removed from the screen housing 12). A leading edge 33 of the screen material 30 is attached to a pull bar 20 having a latch 22, the pull bar 20 being used to advance the screen material 30 across the opening from the screen housing 12 towards the latch housing 14. Also depicted in FIGS. 2 and 4 are edges 32-1 and 32-2 at opposite ends of the screen material 30, with edges 32-1 and 32-2 extending from the leading edge 33 to the trailing edge 34 of the screen material 30. In use, the trailing edge 34 of the screen material 30 is attached to the core 40 such that the screen material 30 can be wound on the core 40 when retracted into the screen housing 12.

Also depicted in FIG. 4 are retainers 36-1 and 36-2 attached, respectively, to edges 32-1 and 32-2 of the screen material 30. Retainers 36-1 and 36-2 may be in the form of, e.g., zipper tapes or any other suitable construction configured to retain the screen material edges 32-1 and 32-2 proximate the screen tracks 16 and 18 of the retractable screen assembly 10 depicted in FIGS. 1-3. The retainers 36-1 and 36-2 preferably have a construction configured to be retained in the screen tracks 16 and 18 as the screen material 30 moves across the opening between screen housing 12 and latch housing 14. Retainers such as, e.g., zipper tapes, etc. are known to those of skill in the art will not be further described herein.

As discussed above, the core 40 extends along a winding axis 40-1, with the core 40 rotating about the winding axis 40-1 to wind or unwind the screen material 30 on the core 40 within the screen housing 12. The force needed to rotate the core 40 to wind the screen material 30 on core 40 can, in one or more embodiments, be provided by winding apparatus located in the screen housing 12 and operably attached to the core 40.

One illustrative embodiment of a winding apparatus as depicted in the exploded view of FIG. 3 includes a lower component 50 and an upper component 52 that, in the depicted embodiment, can be received in the core 42 provide the force needed to rotate the core 40 about the winding axis 40-1. The winding apparatus as depicted in FIG. 3 may, for example, be used in the LUMINAIRE retractable screen assemblies marketed by Andersen Corporation. Examples of other suitable winding assemblies that could be used to rotate a core in a rotatable screen assembly as described herein may be found in, for example: VISTAVIEW screen assemblies marketed by Wizard Industries Inc.; STOW-AWAY screen assemblies by Stoett Industries, Inc.; and others.

The core 40 as depicted in FIGS. 3-4 includes a pair of tension sections 42-1 and 42-2, each of which occupy only a portion of the length of the core 40 as measured between its first end 41-1 and second end 41-2. Each of the tension sections 42-1 and 42-2 have an effective diameter that is greater than the effective diameter of the core 40 outside of the portion of the core occupied by the tension sections 42-1 and 42-2. As a result, the screen material 30 is in tension along a tension zone 35-1 or 35-2 aligned with the corresponding tension section 42-1/42-2 along the length of the screen material (where the length of the screen material is determined between the leading edge 33 and the trailing edge 34 of screen material 30). In the depicted illustrative embodiment, the tension zones 35-1 and 35-2 (along with their corresponding tension sections 42-1/42-2) are spaced apart from the edges 32-1 and 32-2 of the screen material 30.

The tension zones 35-1 and 35-2 are represented by broken lines in each of FIGS. 2 and 4 with tension arrows T provided in each tension zone to represent the tension forces in the screen material 30 between the pull bar 20 and the core 40, more specifically, the tension sections 42-1 and 42-2 on the core 40. In one or more embodiments of the retractable screen assemblies described herein, the screen material in the tension zones 35-1 and 35-2 may be described as delivering an unwinding force to the core 40 through the tension sections 42-1 and 42-2 as the pull bar 20 is moved away from the core 40 during deployment of the screen material 30 and deliver a winding force to the pull bar 20 as the screen material 30 is wound on the core 40 to move the pull bar towards the screen housing 12.

The spacing between the tension zones 35-1 and 35-2 and the nearest edges 32-1 and 32-2 of screen material 30 may provide advantages as discussed herein. In particular, spacing the tension zones 35-1 and 35-2 inward from the edges 32-1 and 32-2 of the screen material 30 ensures that forces exerted on the screen material 30 by the core 40 are carried by the tension sections 42-1 and 42-2 rather than, for example, any retainers 36-1 or 36-2 attached to the edges 32-1/32-2 of the screen material 30. The retainers 36-1 and 36-2 are not depicted in FIG. 2 because they are contained within the screen tracks 16 and 18 and used to ensure full coverage across the building opening along the Y-axis.

In one or more embodiments including a pair of tension sections located proximate opposite edges 32-1 and 32-2 of screen material 30, the tension sections 42-1 and 42-2 may have the same or substantially equivalent effective diameters to provide substantially similar tension forces T in the tension zones 35-1 and 35-2 as the screen material is wound and unwound from the core 40. Those substantially similar tension forces T may promote even extension and retraction of the screen material 30 of the retractable screen assemblies described herein. Also in one or more embodiments, the effective diameters of the tension sections may be uniform over their length, although this is not necessarily required.

In embodiments including a pair of tension sections located proximate opposite edges 32-1 and 32-2 of screen material 30, providing tension sections having the same length may result in tension zones of the same width which may promote even extension and retraction of the screen material 30 of the retractable screen assemblies described herein.

The combination of core 40 and tension sections 42-1 and 42-2 depicted in FIGS. 3-4 represent only one illustrative embodiment of a core and tension section or sections that may be used in the retractable screen assemblies described herein. Other potential alternative embodiments are depicted in FIGS. 5-7 although it should be understood that even these variations represent only a few of the options for cores and tension sections that may be used in the retractable screen assemblies described herein.

The core 140 and tension sections 142-1 and 142-2 depicted in FIG. 5 represent two different optional features when compared to the core 40 and tension sections 42-1 and 42-2 depicted in FIGS. 3-4. For example, the tension sections 142-1 and 142-2 have a longer length between their outer ends 143-1/143-2 and their inner ends 144-1 and 144-2 as compared to the lengths of tension sections 42-1 and 42-2 between their outer ends 43-1/43-2 and inner ends 44-1/44-2.

Another variation between the embodiments depicted in FIGS. 4 and 5 is the spacing between the outer ends 143-1/143-2 of the tension sections 142-1/142-2 and the ends 141-1/141-2 of the core 140 as compared to the spacing between the outer ends 43-1/43-2 of the tension sections 42-1/42-2 and the ends 41-1/41-2 of the core 40 of FIG. 4.

As seen in a comparison between FIGS. 4 and 5, the tension sections 42-1 and 42-2 are located closer to the ends 41-1 and 41-2 of core 40 than the tension sections 142-1 and 142-2 on core 140.

Although described with respect to the spacing between the core ends and the outer ends of the tension sections, this distance is essentially a proxy for the distance between the outer ends of the tension sections and the edges of the screen material. With respect to the embodiment depicted in FIG. 4, the outer ends 43-1 and 43-2 of tension sections 42-1 and 42-2 are located closer to the edges 32-1 and 32-2 of the screen material 30 than the outer ends 143-1 and 143-2 of tension sections 142-1 and 142-2 of core 140 would be if the core and tension sections of FIG. 5 were substituted for the core and tension sections of FIG. 4.

Although not depicted in FIG. 5, it should be understood that the tension zones formed in the screen material 30 would be moved inward from the edges 32-1 and 32-2 of screen material 30 and would also occupy a wider or taller section of the screen material 30 that would correspond generally to the longer length of the tension sections 142-1 and 142-2.

The core 240 and tension section 242 depicted in FIG. 6 represent another illustrative embodiment of a core and tension section combination that may be used in one or more embodiments of the retractable screen assemblies described herein. The embodiment depicted in FIG. 6 includes a single tension section 242 on core 240 with the tension section 242 extending from an outer end 243-1 nearest end 241-1 of core 240 to outer end 243-2 nearest end 241-2 of core 240. The tension section 242 extends over a substantial majority of the core 240 and the corresponding tension zone would, correspondingly, occupy a significant portion of the screen material 30 between edges 32-1 and 32-2.

Core 340 and tension sections 342-1, 342-2 and 342-3 as depicted in FIG. 7 represent another illustrative embodiment of a core and tension section combination that may be useful in one or more embodiments of the retractable screen assemblies described herein. In particular, the embodiment depicted in FIG. 7 includes an intermediate tension section 342-3 positioned between what can be referred to as the outer tension sections 342-1 and 342-2 to provide a tension zone in screen material 30 between the tension zones that would be provided by the outer tension sections 342-1 and 342-2. Although depicted as being of roughly the same length as the outer tension sections 342-1 and 342-2, the intermediate tension section 342-3 may have a different length.

The tension sections provided on cores of retractable screen assemblies as described herein may provide an increased effective diameter relative to the remainder of the core using any suitable combination of techniques and/or components. In one or more embodiments, the core itself may include portions that are machined, molded, or otherwise formed to have an increased diameter relative to the remainder of the core as needed to provide one or more tension zones in the screen material of the retractable screen assembly.

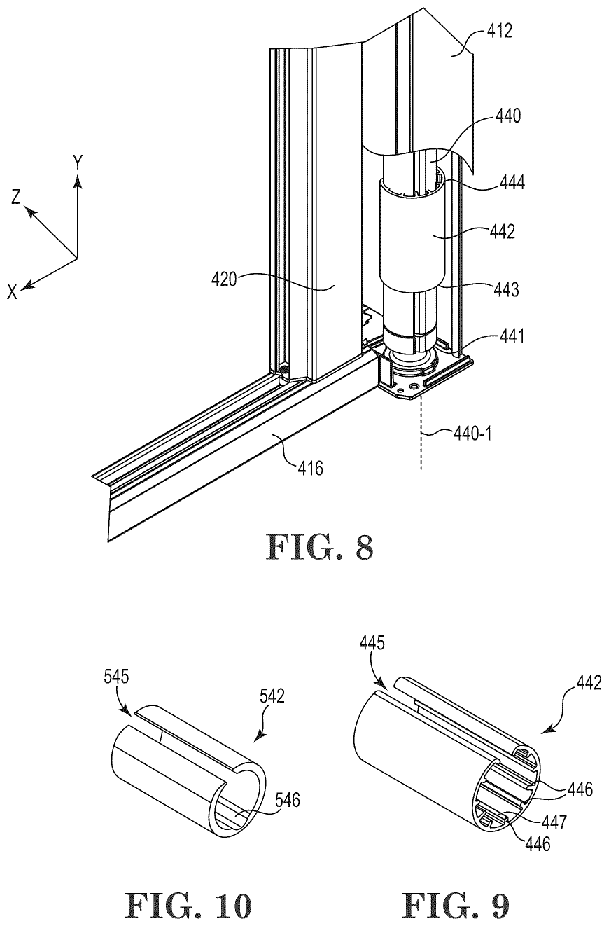

With reference to FIG. 8, one illustrative embodiment of a portion of a retractable screen assembly as described herein is depicted to illustrate one potential technique for providing a tension section on a core of a retractable screen assembly as described herein.

The depicted components include a core 440 located in a screen housing 412, the core 440 having an end 441 with a winding axis 440-1 extending through the core 440. Also depicted are a screen track 416 and a pull bar 420 as described elsewhere herein.

Also included is a tension clip 442 positioned on the core 440 with the tension clip 442 defining a tension section on the core 440. The tension clip includes an outer edge 443 facing the end 441 of core 440 and an inner end 444 facing away from the end 441. The tension clip 442 as a length measured along the winding axis 440-1 from the outer end 443 to the inner end 444 as described in connection with the tension sections discussed herein. The tension clip 442 may be described as a sleeve located on the core 440.

With reference to FIG. 9 in addition to FIG. 8, in the depicted illustrative embodiment, the sleeve/tension clip 442 is configured to be snapped onto or slipped over the core 440 with the gap 445 being used to provide compliance needed to generate the friction that can be used to maintain the position of the sleeve/tension clip 442 on core 440 during use.

The sleeve/tension clip 442 may also include other features configured to retain the sleeve/tension clip 442 in position on a core of a retractable screen assembly as described herein. With reference to FIG. 9, the depicted illustrative embodiment of tension clip 442 includes ribs 446 extending generally radially inward towards a center of the tension clip 442. One or more of the ribs 446 may include an elastomeric or other friction generating material 447 to further enhance friction between the tension clip 442 and the core 440.

FIG. 10 depicts another illustrative embodiment of a sleeve/tension clip 542 that could be used in place of the sleeve/tension clip 442 depicted in FIGS. 8-9. The sleeve/tension clip 542 also includes a longitudinal gap 545 extending along a length of the tension clip 542. Interior features 546 are provided in sleeve/tension clip 542 which may potentially mate or otherwise be retained on features that could be found on a core such as core 440.

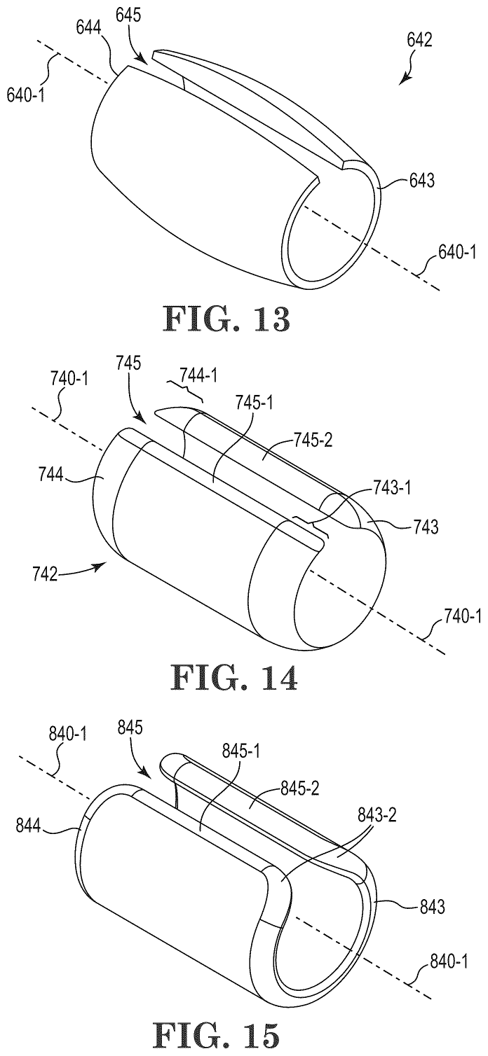

When provided in the form of a clip, one or more embodiments of a tension clip such as tension clip 442 or tension clip 542, the tension clip may be described as occupying a clip arc measured from the winding axis passing through the core. With reference to FIG. 12, the clip arc can be defined by clip angle a (alpha). In one or more embodiments, the clip angle a (alpha) may be greater than 180 degrees, 210 degrees or more, 240 degrees or more, 270 degrees or more, 300 degrees or more, or 330 degrees or more. Increasing the clip angle may correspond with providing improved uniformity in the effective diameter of the tension section defined by a tension clip as described herein.

While friction may be suitable for maintaining the position of a sleeve/tension clip on a core of a retractable screen assembly as described herein, any other suitable technique or combination of techniques could be used in place of and/or in addition to friction including, but not limited to, an interference snap fit between a sleeve/tension clip and core, adhesives, mating or cooperating structures that interlock between the core and sleeve/tension clip, fasteners (, e.g., threaded fasteners, rivets, pins, etc.), etc.

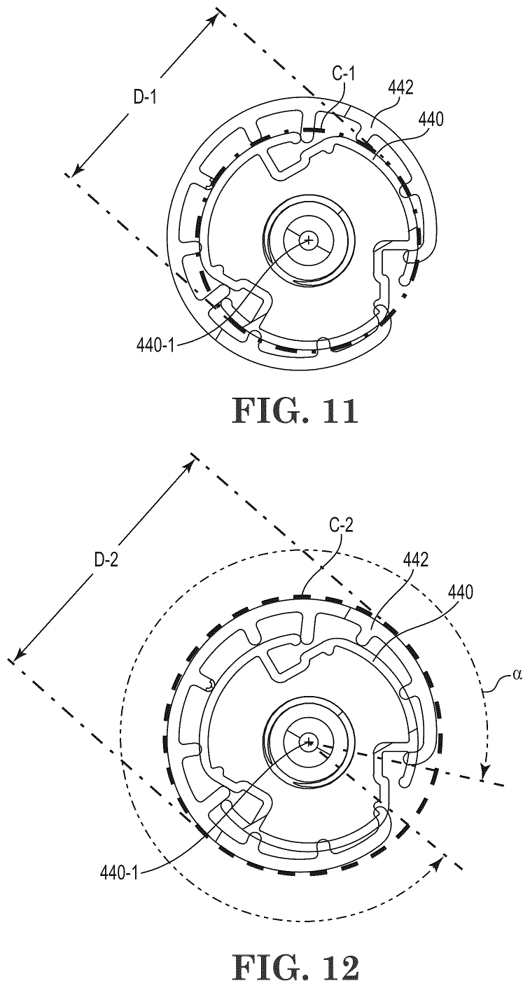

FIGS. 11-12 are two enlarged and/or cross-sectional views of the interface between core 440 and sleeve 442 as seen in, e.g., FIG. 8 and can be used to discuss the relationship between the effective diameter of the core 440 and the effective diameter of the tension clip 442 when installed on core 440.

With reference to FIG. 11, the effective diameter of the core 440 can be defined by circle C-1 which is the smallest circle containing the exterior surface of the core 440 and may, in one or more embodiments, coincide with the surface or surfaces of the core 440 on which screen material would be wound in the absence of the tension clip 442. Typically, circle C-1 would have a center coincident with the winding axis 440-1 although this is not necessarily required. Circle C-1 as defined by the exterior surface of the core 440 has a diameter D-1 which will be referred to herein as the effective core diameter.

With reference to FIG. 12, the effective diameter of the tension clip 442 as mounted on core 440 can be defined by circle C-2 which is the smallest circle containing the exterior surface of the tension clip 442 and the exterior surface of core 440. As above, circle C-2 may have a center coincident with the winding axis 40-1 but that is not required. Circle C-2 as a diameter D-2 which will be referred to herein as the tension section effective diameter.

To provide the tension zones in screen material of retractable screen assemblies as described herein, the tension section effective diameters D-2 are greater than the effective core diameters D-1 because the screen material wound onto the larger diameter tension sections carries the winding and unwinding forces as described herein.

It has been found that a variety of factors can be adjusted to provide different performance parameters in retractable screen assemblies using cores having tension sections as described herein. For example, it has been found that even extension and retraction of the pull bar/screen material leading edge can be improved by increasing the diameter of the tension sections and/or moving the tension sections further away from the edges of the screen material.

It has also been found that reducing the diameter of the tension sections and/or moving the tension sections closer to the edges of the screen material can result in shortening and/or reducing wrinkling or deformation of the screen material between the outer ends of the tension sections and the edges of the screen material.

It has further been found that reductions in friction and increases in retraction speed in the retractable screen assemblies described herein can be obtained by reducing the diameter of the tension sections and/or moving the tension sections closer to the edges of the screen material.

In view of these competing factors, in one or more embodiments of the retractable screen assemblies described herein, it may be advantageous to provide tension sections having the tension section effective diameters that are 105 percent or more, 110 percent or more of the effective core diameters; 115 percent or more of the effective core diameters; 120 percent or more of the effective core diameters, or 125 percent or more of the effective core diameters. At an upper end, it may be advantageous to limit the tension section effective diameters to 150 percent or less of the effective core diameters, 140 percent or less of the effective core diameters, or 130 percent or less of the effective core diameters. It has been found that within these limits, acceptable performance of the retractable screen assemblies can be achieved.

As discussed herein, variation in placement of the tension sections on cores of retractable screen assemblies as described herein also affects performance. It has been found that, at an upper end, a distance between the edge of the screen material and the outer end of a tension section nearest to that edge of screen material may preferably be 15 times or less of the tension section effective diameter, 12 times or less of the tension section effective diameter, 10 times or less of the tension section effective diameter, 8 times or less of the tension section effective diameter, 6 times or less of the tension section effective diameter, 4 times or less of the tension section effective diameter, 2 times or less, equal to or less, 0.5 times or less, or 0.2 times or less of the tension section effective diameter. The lower end of the distance between the edge of the screen material and the outer end of a tension section nearest to that edge of screen material may, be relatively small with only sufficient space required to form effective tension zones using the tension sections as described herein. For example, in one or more embodiments, the distance between the edge of the screen material and the outer end of the tension section nearest to that edge of screen material may be 10 percent or more, 20 percent or more of the tension section effective diameter, 30 percent or more of the tension section diameter, 40 percent or more of the tension section diameter, or 50 percent or more of the tension section diameter.

FIGS. 13-15 depict additional alternative illustrative embodiments of sleeve/tension clips that could be used in place of the sleeve/tension clip 442 depicted in FIGS. 8-9 and/or sleeve/tension clip 542 depicted in FIG. 10 in one or more embodiments of the retractable screen assemblies described herein.

FIG. 13 depicts a tension clip 642 that is configured to be snapped onto or slipped over the core of a retractable screen assembly as described herein. The tension clip 642 includes a gap 645 to provide compliance needed to generate friction that can be used to maintain the position of the sleeve/tension clip 642 on a core during use (although other mechanisms/techniques for maintaining the position of the tension clip 642 on a core could be used in place of or in addition to friction as discussed herein.

Tension clip 642 includes an optional feature in the form of a tension section effective diameter (when mounted on a core) that increases when moving along winding axis 640-1 from outside end 643 or inside end 644 towards the center of the tension clip 642. Although not wishing to be bound by theory, wrinkling or other deformations of the screen material wound on a core on which tension clip 642 is located may be reduced when the tension section effective diameter changes when moving from the outside end 643 towards the center of the length of the tension clip 642 (where the length is measured from the outside end 643 to the inside end 644 along winding axis 640-1). In the depicted embodiment of tension clip 642, both ends 643 and 644 have a smaller tension section effective diameter than the center of the tension clip 642 so that the tension clip 642 can be mounted on either end of core without regard to its orientation.

For purposes of the relationships between tension section effective diameter and the effective core diameter as discussed herein, the tension section effective diameter (e.g., diameter D-2 in FIG. 12) is measured at the thickest portion of the tension clip 642 which results in the maximum tension section effective diameter (where the thickness of the tension clip 642 is measured radially outward from the winding axis 640-1). In the depicted embodiment of tension clip 642, that maximum tension section effective diameter would be found at the center of the length of the tension clip 642 between ends 643 and 644.

In one or more embodiments of a retractable screen assembly including a tension clip with a varying diameter as described in connection with tension clip 642, the tension section provided by the tension clip 642 can be described as having a section length measured along the winding axis 640-1 in which the tension section effective diameter increases over at least a portion of the section length when moving away from the first edge of the screen material.

Although the increasing tension section effective diameter is embodied in a tension clip 642 configured to be mounted on a core of a retractable screen assembly as described herein, it should be understood that this feature could also be provided in a core in which the tension zones having an increased effective diameter relative to the remainder of the core are provided using any suitable combination of techniques and/or components. As described herein one or more embodiments of a core itself may include portions that are machined, molded, or otherwise formed to have an increased diameter relative to the remainder of the core as needed to provide one or more tension zones in the screen material of the retractable screen assembly (as depicted in, e.g., FIGS. 5-7 where tension sections 142-1, 142-2, 242, 342-1, 342-2, and 342-3 may be integrated into the cores 140, 240, and 340 as compared to being provided by separate tension clips as described herein). If tension sections are provided in the core (i.e., not by a clip mounted on a core), the varying thickness/effective tension section diameter would be expected to (potentially) provide the same benefits discussed herein with respect to tension clips.

FIG. 14 depicts another illustrative embodiment of a tension clip 742 that is configured to be snapped onto or slipped over the core of a retractable screen assembly as described herein. The tension clip 742 includes a gap 745 to provide compliance needed to generate friction that can be used to maintain the position of the sleeve/tension clip 742 on a core during use (although other mechanisms/techniques for maintaining the position of the tension clip 742 on a core could be used in place of or in addition to friction as discussed herein.

Tension clip 742 includes optional features in the form of rounded edges 745-1 and 745-2 on opposite sides of the gap 745. Although not wishing to be bound by theory, the potential for damage to screen material wound onto a core over the tension clip 742 may be reduced as compared to tension clips having sharper edges.

Tension clip 742 also includes an outside end 743 and inside end 744 that also include rounded transition sections (respectively 743-1 and 744-1) to the central portion of the tension clip 742. Again, although not wishing to be bound by theory, the potential for damage to screen material wound onto a core over the tension clip 742 may be reduced as compared to tension clips having sharper edges. In the depicted embodiment of tension clip 742, both ends 743 and 744 include rounded transition sections so that the tension clip 742 can be mounted on either end of core without regard to its orientation.

FIG. 15 depicts another illustrative embodiment of a tension clip 842 that is configured to be snapped onto or slipped over the core of a retractable screen assembly as described herein. The tension clip 842 includes a gap 845 to provide compliance needed to generate friction that can be used to maintain the position of the sleeve/tension clip 842 on a core during use (although other mechanisms/techniques for maintaining the position of the tension clip 842 on a core could be used in place of or in addition to friction as discussed herein.

Tension clip 842 includes optional features in the form of rounded corners 843-2 on opposite sides of the gap 845 at the outside end 843 of the tension clip 842. Although not wishing to be bound by theory, the potential for damage to screen material wound onto a core over the tension clip 842 may be reduced as compared to tension clips having sharper corners.

Tension clip 842 includes an inside end 844 that also includes rounded corners on opposite sides of the gap 845 at the inside end 844 of the tension clip 842 so that the tension clip 842 can be mounted on either end of core without regard to its orientation.

Although the various transitions depicted in FIGS. 14-15 are embodied in tension clips mounted on a core of a retractable screen assembly as described herein, it should be understood that the features could also be provided in a core in which the tension zones are created by tension sections in the core as described herein. If embodied in tension sections that are not formed using clips, the rounded edges/corners would be expected to (potentially) provide the same benefits discussed herein with respect to tension clips.

As discussed above in connection with the illustrative embodiments depicted in FIGS. 4-7, the tension sections may have a section length measured along a winding axis extending through the core on which the tension sections are located. The tension section length is measured from an outer end to an inner end of the tension section/tension clip. That section length may, in one or more embodiments, be greater than the tension section effective diameter (e.g., diameter D-2 of tension clip 442 mounted on core 440 as depicted in FIGS. 8 and 11-12). In one or more embodiments, the section length may be 10 percent or more, 20 percent or more, 30 percent or more, 40 percent or more, 50 percent or more, 100 percent or more, 120 percent or more, or 150 percent or more of the tension section effective diameter. Providing tension sections having a length greater than the tension section effective diameter results provides for effective distribution of the forces generated by the increased diameter of the tension section on the screen material.

In one or more embodiments, the section length of the tension sections of retractable screen assemblies as described herein may also have an upper limit that can provide advantages to the retractable screen assemblies described herein. In one or more embodiments, the tension section length may be limited to 10 times or less, 8 times or less, 6 times or less, 4 times or less, or 2 times or less of the tension section effective diameter (e.g., diameter D-2 in FIG. 12). Providing an upper limit on the length of the tension sections on cores of retractable screen assemblies as described herein may provide advantages such as, e.g., increasing retraction speed, reducing the amount of material required, etc.

In view of the factors discussed above, i.e., providing for even advancement and/or retraction of a pull bar and attached screen material, limiting wrinkles or other deformations in the screen material, and providing an acceptable retraction speed in a retractable screen assembly having an effective core diameter of approximately 1.375 inches and designed for placement over a building opening having a size in the range of 24 to 60 inches by 80 to 96 inches, it may be advantageous to provide a pair of tension clips on the core, with the tension clips having a length of about 3 inches and a thickness resulting in a tension section effective diameter of approximately 1.75 inches. Placing these tension clips at a position approximately 1 to 2 inches from the edge of the screen material has resulted in an acceptable balance between even advancement/retraction, wrinkles or other deformations, and retraction speed in a retractable screen assembly as described herein. Although that particular combination of features provides acceptable performance, it should be understood that other combinations of features may also provide acceptable performance. For example, in one or more embodiments, a pair of tension sections defined by tension clips with a length of approximately 3 inches attached to a core having a diameter of approximately 1.375 inches and spaced anywhere from 9 to 18 inches from the edges of the screen material also provided acceptable performance.

It must, therefore, be understood that these particular combinations of features/dimensions can be adjusted to achieve acceptable performance in a retractable screen assembly as described herein based on a wide variety of factors including, but not limited to, the effective diameter of the core, the screen material itself (e.g., stiffness, flexibility, etc.), the size of the retractable screen assembly (e.g., the dimensions between the leading and trailing edges and/or between the opposing edges), the orientation of the retractable screen assembly (e.g., is the screen being moved vertically or horizontally), the forces generated by any winding apparatus used in the retractable screen assembly, etc.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a system or method that “comprises” a list of elements (e.g., components or features or steps) is not necessarily limited to only those elements (or components or features or steps), but may include other elements (or components or features or steps) not expressly listed or inherent to the method.

As used herein, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

Further, the term “comprises” and variations thereof do not have a limiting meaning where these terms appear in the accompanying description. Moreover, “a,” “an,” “the,” “at least one,” and “one or more” are used interchangeably herein.

The complete disclosure of the patents, patent documents, and publications identified herein are incorporated by reference in their entirety as if each were individually incorporated. To the extent there is a conflict or discrepancy between this document and the disclosure in any such incorporated document, this document will control.

From the above disclosure of the general principles of the present invention and the preceding description, those skilled in this art will readily comprehend the various modifications, re-arrangements and substitutions to which the present invention is susceptible, as well as the various advantages and benefits the present invention may provide. Therefore, the scope of the invention should be limited only by the following claims and equivalents thereof.

1. A retractable screen assembly comprising:
a screen housing configured for attachment to a first side of a building opening;
a core retained in the screen housing, the core comprising a core length extending along a winding axis from a first end to a second end;
screen material wound on the core in the screen housing, the screen material comprising a first edge proximate the first end of the core, a second edge proximate the second end of the core, a leading edge extending from the first edge to the second edge, and a trailing edge extending from the first edge to the second edge, wherein the trailing edge is attached to the core and remains in the screen housing during use of the retractable screen assembly and wherein the screen material comprises a length measured between the leading edge and the trailing edge; and
a pull bar attached to the leading edge of the screen material, the pull bar configured to unwind the screen material from the core when moved away from the screen housing;
wherein the core comprises a tension section occupying only a portion of the core length between the first edge of the screen material and the second edge of the screen material, wherein the tension section comprises a tension section effective diameter that is greater than an effective core diameter outside of the portion of the core length occupied by the tension section, such that the screen material is in tension along a tension zone aligned with the tension section along the length of the screen material, the tension zone also aligned with but spaced apart from the first edge of the screen material.

2. The retractable screen assembly of claim 1, wherein the screen material in the tension zone is configured to deliver an unwinding force to the core through the tension section as the pull bar is moved away from the core during deployment of the screen material and deliver a winding force to the pull bar as the screen material is wound on the core.

3. The retractable screen assembly of claim 1, wherein the tension section effective diameter is 105 percent or more of the effective core diameter between the tension section and the first edge of the screen material.

4. The retractable screen assembly of claim 3, wherein the tension section effective diameter is 150 percent or less of the effective core diameter between the tension section and the edge of the screen material.

5. The retractable screen assembly of claim 1, wherein the tension section comprises a section length measured along the winding axis that is 10 percent or more of the tension section effective diameter.

6. The retractable screen assembly of claim 5, wherein the section length is 10 times or less of the tension section effective diameter.

7. The retractable screen assembly of claim 1, wherein the tension section extends along the core from an outer section end to an inner section end, wherein the outer section end is located closer to the first edge of the screen material than the inner section end, and wherein a section distance between the first edge of the screen material and the outer section end is 15 times or less of the tension section effective diameter.

8. The retractable screen assembly according to claim 7, wherein the section distance between the first edge of the screen material and the outer section end of the tension section is 10 percent or more of the tension section effective diameter.

9. The retractable screen assembly of claim 1, wherein the tension section comprises a tension clip attached to the core, wherein the tension clip occupies a clip arc measured from the winding axis on a perimeter of the core, wherein the clip arc is greater than 180 degrees.

10. The retractable screen assembly of claim 1, wherein the tension section comprises a first tension section occupying a first portion of the core length and wherein the retractable screen assembly comprises a second tension section occupying a second portion of the core length between the first tension section and the second edge of the screen material, wherein the second tension section comprises a second tension section effective diameter that is greater than an effective core diameter outside of the second portion of the core length occupied by the second tension section, such that the screen material is in tension along a second tension zone aligned with the second tension section along the length of the screen material, the second tension zone also aligned with but spaced apart from the second edge of the screen material.

11. The retractable screen assembly of claim 10, wherein the screen material in the second tension zone delivers an unwinding force to the core through the second tension section as the pull bar is moved away from the core during deployment of the screen material and deliver a winding force to the pull bar as the screen material is wound on the core.

12. The retractable screen assembly of claim 10, wherein the second tension section effective diameter is 105 percent or more of the effective core diameter between the second tension section and the second edge of the screen material.

13. The retractable screen assembly of claim 10, wherein the second tension section effective diameter is equal to the tension section effective diameter of the first tension section.

14. The retractable screen assembly of claim 10, wherein the second tension section comprises a second section length measured along the winding axis that is 10 percent or more of the second tension section effective diameter and 10 times or less of the second tension section effective diameter.

15. The retractable screen assembly of claim 10, wherein the second tension section extends along the core from a second outer section end to a second inner section end, wherein the second outer section end is located closer to the second edge of the screen material than the second inner section end, and wherein a second section distance between the second edge of the screen material and the second outer section end is 15times or less of the second tension section effective diameter, and wherein the second section distance between the second edge of the screen material and the outer section end of the second tension section is 10 percent or more of the second tension section effective diameter.

16. The retractable screen assembly of claim 10, wherein the second tension section comprises a second tension clip attached to the core, wherein the second tension clip occupies a second clip arc measured from the winding axis on a perimeter of the core, wherein the second clip arc is greater than 180 degrees.

17. The retractable screen assembly of claim 1, wherein the retractable screen assembly comprises a first retainer attached to the first edge of the screen material and a second retainer attached to the second edge of the screen material, wherein the first retainer is wound about the winding axis within the screen housing proximate the first end of the core, and wherein the second retainer is wound about the winding axis within the screen housing proximate the second end of the core.

18. The retractable screen assembly of claim 17, wherein the retractable screen assembly comprises a first track extending away from the screen housing proximate the first end of the core and a second track extending away from the screen housing proximate the second end of the core, wherein a first end of the pull bar and the first retainer pass through a first channel in the first track when the pull bar is moved away from the screen housing to unwind the screen material, and wherein a second end of the pull bar and the second retainer pass through a second channel in the second track when the pull bar is moved away from the screen housing to unwind the screen material.

19. The retractable screen assembly of claim 10, wherein the second tension section effective diameter is 150 percent or less of the effective core diameter between the second tension section and the second edge of the screen material.

20. The retractable screen assembly of claim 1, wherein the tension section comprises a section length measured along the winding axis, and wherein the tension section effective diameter increases over at least a portion of the section length when moving away from the first edge of the screen material.

21. A method of deploying a retractable screen across a building opening, the method comprising:
unwinding screen material wound on a core in a screen housing attached to a first side of a building opening by moving a pull bar attached to a leading edge of the screen material away from the screen housing along a deployment direction;
wherein the unwinding comprises applying an unwinding force to a tension section of the core, wherein the tension section occupies only a portion of the core between a first edge of the screen material and a second edge of the screen material, wherein the tension section comprises a tension section effective diameter that is greater than an effective core diameter outside of the portion of the core occupied by the tension section;
wherein the unwinding force is applied to the tension section by a tension zone extending from the pull bar to the tension section;
and wherein the tension zone is aligned with but spaced apart from the first edge of the screen material.

22. The method of claim 21, wherein the tension zone comprises a first tension zone and the unwinding force applied by the first tension zone is a first unwinding force, and wherein the method comprises:
applying a second unwinding force to a second tension section of the core, wherein the second tension section occupies only a portion of the core between a first tension section and the second edge of the screen material, wherein the second tension section comprises a second tension section effective diameter that is greater than an effective core diameter outside of the portion of the core occupied by the second tension section;
wherein the second unwinding force is applied to the second tension section by a second tension zone extending from the pull bar to the second tension section;
and wherein the second tension zone is aligned with but spaced apart from the second edge of the screen material.

23. The method of claim 22, wherein the first unwinding force and the second unwinding force are equivalent to each other.
